(19) United States
(12) Patent Application Publication
(10) Pub. No.: US 2026/0175620 A1
(43) Pub. Date: Jun. 25, 2026

(54) AXLE FLANGE

(71) Applicant: Dana Automotive Systems Group, LLC, Maumee, OH (US)

(72) Inventors: Durganand KULKARNI, Pune (IN); Sandeep Bhagoji PATIL, Pune (IN); Michael BOWSER, Maumee, OH (US); Kevin POUTER, Maumee, OH (US)

(21) Appl. No.: 18/999,820

(22) Filed: Dec. 23, 2024

(51) Int. Cl. B60B 35/12; B60B 27/00; B60B 27/06; B60T 1/06

(52) U.S. Cl. CPC B60B 35/122; B60B 27/0073; B60B 27/065; B60T 1/067

(57) ABSTRACT

Systems are provided for reducing an input weight to net weight ratio of an axle shaft, by eliminating a flange used to couple a shaft of the axle to a wheel of the vehicle. A conventional axle shaft may be bolted to the wheel via wheel bolts that extend through holes in the flange. In one example, an axle shaft is provided that includes splines at both ends, where one end of the axle shaft is coupled to the wheel drum via a splined connection, and are held in place by a lock nut and lock pin, eliminating a reliance on the axle flange. As a result, an amount of material wasted during forging of the axle is reduced, and an assembly/disassembly of the axle may be simplified. Additionally, a torque transmitting capability of the axle shaft may be increased.

### TECHNICAL FIELD

Embodiments of the subject matter disclosed herein relate generally to a drive axle of a vehicle.

### BACKGROUND

An electric drive axle of a vehicle may include an electric motor coupled with a gearbox. A rotor shaft of the electric motor may be coupled to an input gear shaft of the gearbox via a gear of the gearbox. An output shaft of the gearbox may be coupled to a wheel of the vehicle via a differential gear assembly, where a rotation of the output shaft by the electric motor via the gearbox generates a torque in the wheel to propel the vehicle. The output shaft may also be referred to as an axle shaft. The axle shaft may include a flange, which is used to bolt the axle shaft to the wheel. The flange adds weight to the axle shaft and results in low yield (ratio of net weight to gross weight) of the axle shaft.

### SUMMARY

In one example, the issues described above may be addressed by an axle and brake assembly of a vehicle, the axle and brake assembly comprising an axle shaft including a first set of splines at a first end of the axle shaft; a brake drum with a hub including set of inner splines arranged around an inner circumference of the hub, the hub configured to receive the first set of splines and engage the first set of splines with the set of inner splines; and one of a caulked nut and a lock nut/lock pin combination configured to secure the axle shaft to the brake drum without any other fasteners; wherein the axle shaft does not include a flange.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 schematically shows an exemplary vehicle including an electric drive axle;

FIG. 2 illustrates a coupling of a shaft of the electric drive axle with a braking assembly of a wheel of the vehicle, as prior art;

FIG. 3 shows an exemplary axle shaft including splines at both ends of the shaft;

FIG. 4 is a first perspective view of an exemplary brake drum and hub of the braking assembly;

FIG. 5 is a second perspective view of the brake drum and hub of the braking assembly;

FIG. 6 shows a proposed exemplary braking assembly of the wheel;

FIG. 7 shows a coupling of the exemplary axle shaft with the exemplary braking assembly;

FIG. 8 shows an exemplary end of a bolt coupling the exemplary axle shaft to the exemplary braking assembly; and

FIG. 9 shows an exemplary caulked nut coupling the bolt of FIG. 8 to the exemplary braking assembly.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

The following disclosure relates to an electric axle of a vehicle. The concept is however electric vehicle (EV) agnostic and can be used on both EV and internal combustion engine (ICE) applications. A conventional axle shaft may be bolted to the wheel via wheel bolts that extend through holes in the flange. An alternative axle shaft is provided herein that includes splines at both ends, where one end of the axle shaft is coupled to the wheel drum via a splined connection, and are held in place by a lock nut and lock pin, eliminating a reliance on the axle flange. As a result, a weight of the axle is reduced, and an assembly/disassembly of the axle may be simplified.

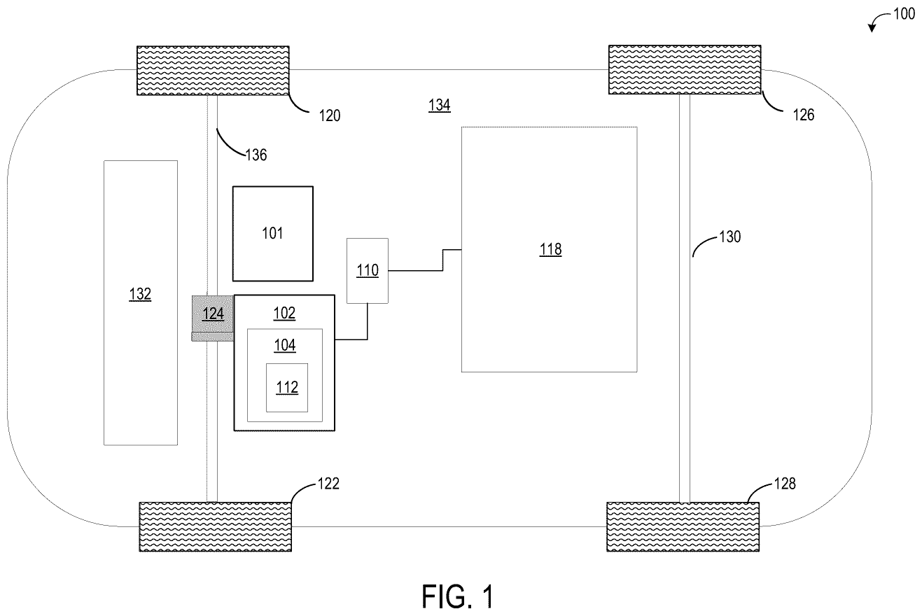

Referring now to FIG. 1, an example vehicle 100 is shown. In some examples, vehicle 100 may be a hybrid vehicle configured to provide torque to one or more wheels from multiple sources, such as engine 101 and electric motor 102. In other examples, vehicle 100 is configured to provide torque to the one or more wheels via only one of engine 101 or electric motor 102. In the example in which vehicle 100 is a hybrid vehicle, operation of the vehicle 100 may be adjusted between various different modes in which torque is supplied to the one or more wheels via only engine 101, via only electric motor 102, or via a combination of engine 101 and electric motor 102. Electric motor 102 may be a motor/generator configured to provide torque output to the one or more wheels and to generate electrical energy during operation of the vehicle 100 (e.g., via regenerative braking, as one example). Vehicle 100 is provided as an example of a system including an electric axle (also referred to herein as an E-axle) as described herein. As such, electric motor 102 may be referred to as E-axle 102. However, vehicle 100 is not intended to be limiting, and in some examples E-axle 102 may be included in vehicles having a different configuration (e.g., a different number and/or relative configuration of wheels and/or other components).

Vehicle 100 may be powered by electric motor 102 and/or engine 101, which generates torque in a drive wheel 120 when one or more clutches are engaged via a gearbox 104 of E-axle 102. In FIG. 1, E-axle 102 is rotatably coupled to an input of a differential gear assembly 124, which may generate a torque at a first drive wheel 120 via an axle drive shaft 136. In some examples, the torque may be applied to an additional drive wheel, such as second wheel 122 by differential gear assembly 124 may be different (for example, during cornering of the vehicle or operation on an uneven ground surface), and in some conditions it may be approximately the same (for example, while driving the vehicle straight on a level ground surface, without cornering). Vehicle 100 may also include one or more free wheels, such as free wheels 126 and 128 mounted on free axle 130. Free wheels 126 and 128 may rotate as the vehicle is driven without being directly propelled by engine 101 or electric motor 102 (e.g., the engine and electric motor do not apply torque directly to the axle coupled to the free wheels). In other embodiments, additional free wheels may be included on free axle 130, and/or additional free axles may be included in vehicle 100, each of which may include a plurality of wheels. For example, heavy trucks or buses may have additional front and/or rear axles to distribute the weight of cargo, and each axle may include two wheels on each side.

As shown in the illustrated example, first drive wheel 120 and second wheel 122 may be front wheels. In other embodiments, first drive wheel 120 and second wheel 122 may be rear wheels, and the front wheels may be free wheels, or a transfer case (not depicted in FIG. 1) may be used to power all the wheels on vehicle 100, for example, in the case of 4-wheel drive vehicles or all-wheel-drive vehicles. The position or number of drive wheels on vehicle 100 should not be construed as limiting the scope of this disclosure.

In various embodiments, gearbox 104 may be an automatic gearbox, whereby shifting of one or more gears of gearbox 104 may be handled automatically by an electronic controller 110. For automatic shifting, electronic controller 110 may be communicatively coupled to a shift assembly 112 of gearbox 104 that engages gears of gearbox 104. For example, electronic controller 110 may command the shift assembly 112 to various positions in order to engage and/or disengage gears of gearbox 104. Shift assembly 112 may include actuator sensors from which the electronic controller 110 may receive data used to control operation of shift assembly 112 (e.g., to adjust a selected gear of gearbox 104). Electronic controller 110 may also receive input from other sensors of vehicle 100, such as wheel sensors, pedal position sensors, temperature sensors, pressure sensors, speed sensors, throttle sensors, battery charge sensors, air-fuel ratio sensors, etc. Electronic controller 110 may send control signals to various actuators communicatively coupled to E-axle 102, engine 101, and/or other components of vehicle 100. The various actuators may include motors of the shift assembly that engage the gears of gearbox 104, for example, by sliding synchronizer rings and clutches along an output shaft of gearbox 104 via shift forks (not depicted in FIG. 1). The various actuators may also include, for example, various valves, throttles, fuel injectors, etc. The types of sensors and actuators listed herein are for illustrative purposes and any type of sensors and/or actuators may be included without departing from the scope of this disclosure.

E-axle 102 may be powered by a battery pack 118. Battery pack 118 may be an energy storage device configured to deliver electrical power to various components of the electrical system of the vehicle 100 including supplying current to E-axle 102 coupled to front wheels 120 and 122 and/or other powered wheels of vehicle 100. Battery pack 118 may be electrically coupled to E-axle 102 and/or electronic controller 110. Electronic controller 110 may regulate a power supplied by battery pack 118 to E-axle 102 in order to increase or decrease the speed of vehicle 100.

Engine 101 may be powered by fuel such as gasoline, diesel fuel, natural gas, biofuels, or any other combustible fuel; and accordingly, vehicle 100 may include a fuel tank connected to engine 101 via a fuel pump and intake system. Engine 101 and/or E-axle 102 may be positioned on a chassis 134 in a variety of configurations. For example, engine 101 and E-axle 102 may be positioned proximate to each other, or engine 101 and electric motor may be positioned further apart from each other along the chassis 134.

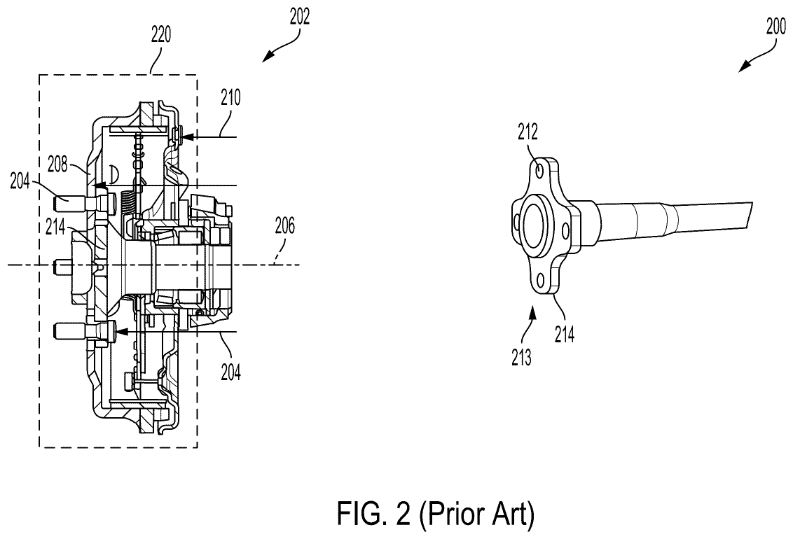

FIG. 2 shows a coupling of a conventional axle shaft 200 with a conventional braking assembly 202 of a wheel 220 of a vehicle, such as vehicle 100 of FIG. 1. Braking assembly 202 comprises at least a brake 210 and a brake drum 208. Axle shaft 200 includes a flange 214 positioned at an end 213 of axle shaft 200. Axle shaft 200 may be coupled to braking assembly 202 at a central axis 206 of braking assembly 202 via a plurality of wheel bolts 204, which may extend through a respective plurality of bolt holes 212 arranged in flange 214. In the depicted embodiment, four wheel bolts 204 couple braking assembly 202 to the wheel, and flange 214 includes four respective bolt holes 212. In other embodiments, a different number of wheel bolts 204 may be used, and flange 214 may include a different number of bolt holes 212. In the depicted embodiment, axle shaft 200 is coupled to braking assembly 202 using a double taper bearing. In other embodiments, a different wheel bearing arrangement may also be used, such as a ball bearing, unitized bearing, etc.

Flange 214 is an integrated part of axle shaft 200, and adds weight to axle shaft 200. For example, flange 214 may weigh 1-3 kg on light vehicle applications. In one example, a net weight to input weight ratio of axle shaft 200 may be approximately 62%, where the input weight to forge axle shaft 200 is 38% more than the weight of the finished shaft. For example, if we have a finished axle shaft 200 that weighs 8 kg, then the input weight of the bar used to forge axle shaft 200 may be approximately 8×1.38=11.04 kg. This represents 3.03 kg of wasted material. As described in greater detail below, by removing flange 214, an amount of the wasted material may be advantageously reduced.

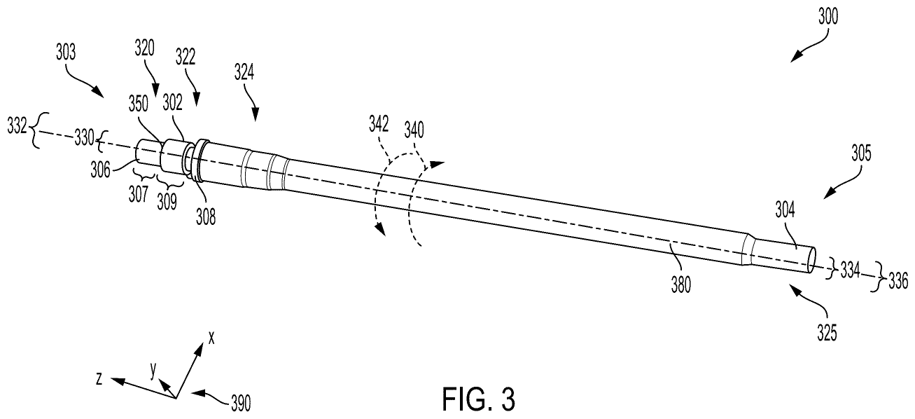

As a result of the design of conventional axle shaft 200 and conventional braking assembly 202, when the brakes are outboard of bearing retainer in a semi-float axle design, an assembly and disassembly of braking assembly 202 during servicing may be complex, which may increase an amount of time demanded for servicing. To reduce the complexity of the assembly and disassembly of braking assembly 202 during servicing, an alternative design of axle shaft 200 is proposed, which is shown in FIG. 3.

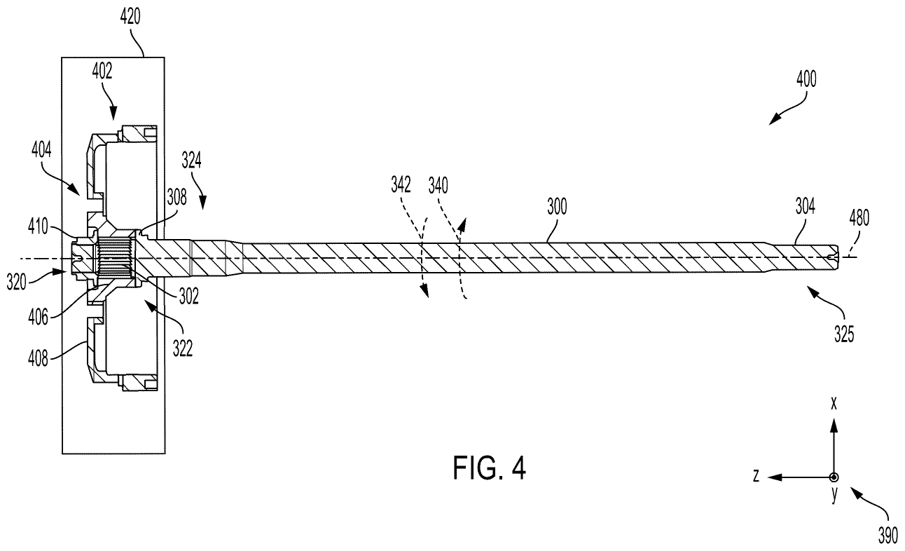

FIG. 3 shows an exemplary axle shaft 300 of a driveline of a vehicle, which may be a non-limiting example of axle drive shaft 136 of vehicle 100 of FIG. 1. Axle shaft 300 may be a front drive shaft, or a rear drive shaft. Axle shaft 300 may be configured to rotate around a central axis 380 of axle shaft 300. A first end 303 of axle shaft 300 may be configured to couple with a braking assembly positioned at a drive wheel of a vehicle, such as drive wheel 120. The coupling may be achieved via a first portion 320 and a second portion 322 of axle shaft 300 at first end 303. First portion 320 may include a threaded section 306 of axle shaft 300, which may be coupled to a brake drum hub of the braking assembly via a nut (not shown in FIG. 3). Examples of the brake drum hub are shown in FIGS. 4-7. Threaded section 306 has a first diameter 330, which may be less than a second diameter 336 of axle shaft 300. Threaded section 306 may have a first axial length 307.

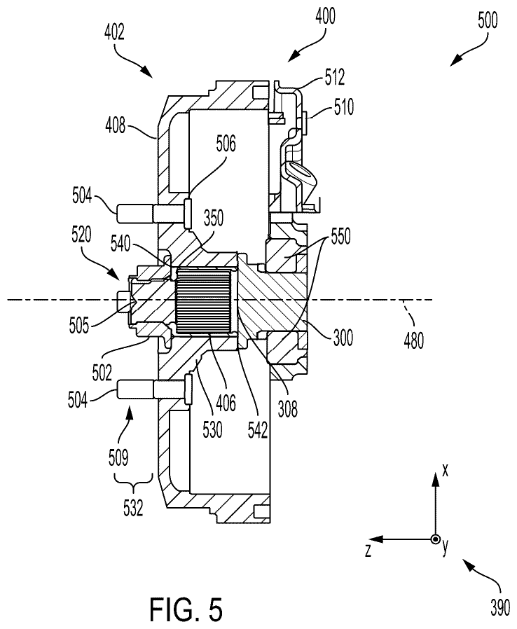

Second portion 322 of axle shaft 300 includes a first set of splines 302 arranged around an outer circumference of axle shaft 300, extending along axle shaft 300 in an axial direction or substantially parallel to central axis 380 and radially extending outward from axle shaft 300. In some embodiments, a third diameter 332 of second portion 322, as measured from central axis 380 to an outer circumference of the first set of splines 302, may be greater than second diameter 336 of axle shaft 300. In other embodiments, third diameter 332 may be equal to second diameter 336 or less than second diameter 336. The first set of splines 302 may have a second axial length 309. The first set of splines 302 may be configured to couple with a set of inner splines arranged around an inner circumference of a hub of a brake drum, as shown in the axle and brake assembly of FIG. 4. The first set of splines may engage the set of inner splines directly, meaning, without an intervening adapter ring. As a result of first diameter 330 being less than third diameter 332, axle shaft 300 may include a lip 350 at a border between first portion 320 and second portion 322 (e.g., at an edge of the first set of splines 302). Lip 350 may allow first portion 320 to extend and protrude through the brake drum hub, and not allow second portion 322 to protrude through the brake drum hub, as described in greater detail below in reference to FIG. 5.

In this way, axle shaft 300 may be coupled to the brake drum hub via a combination of the nut and threaded section 306, which secure axle shaft 300 to the brake drum hub along central axis 380 of axle shaft 300, in a z dimension indicated by reference axes 390, and the first set of splines 302, which rotatably couple axle shaft 300 to the brake drum hub such that a rotation of axle shaft 300 generates a torque that is applied to a wheel coupled to the brake drum hub via an engagement of the first set of splines 302 with the inner splines arranged around an inner circumference of a brake drum hub. As a result of the coupling of axle shaft 300 with the brake drum hub at first portion 320 and second portion 322 of axle shaft 300, a flange (e.g., flange 214 of FIG. 2) is not relied on to bolt axle shaft 300 to the brake drum hub.

Axle shaft 300 may be a stepped shaft, where at a portion 324 of axle shaft 300, the diameter of axle shaft may be increased over one or more steps to optimize weight and maintain a bending strength and torsional stiffness and balance of axle shaft 300. The diameters of the one or more steps may be based on a bending load of axle shaft 300. Axle shaft 300 may further include a sealing ring 308 that protrudes radially outward from axle shaft 300 at a border between second portion 322 and a third, stepped portion 324 of axle shaft 300. Sealing ring 308 may be configured to seal a coupling of axle shaft 300 with the brake drum hub and prevent dirt and debris from passing in between the first set of splines 302 and the inner splines arranged around the inner circumference of the brake drum hub.

The rotation of axle shaft 300 that generates the torque at the wheel may be generated in a clockwise direction 340 or a counterclockwise direction 342 by a differential gear assembly, such as differential gear assembly 124 of FIG. 1. Axle shaft 300 may be coupled to the differential gear assembly at a second end 305 (e.g., an inboard side) of axle shaft 300. Second end 305 may be coupled to an output shaft of the differential gear assembly via a second set of splines 304, which may be arranged around an outer circumference of axle shaft 300 extending radially outward from axle shaft 300 at a fourth portion 325 of axle shaft 300. The second set of splines 304 may engage with a side gear of the differential gear assembly, for example. A fourth diameter 334 of fourth portion 325, as measured from central axis 380 to an outer circumference of the second set of splines 304, may be less than second diameter 336 of axle shaft 300. In other embodiments, fourth diameter 334 may be equal to or greater than second diameter 336.

FIG. 4 shows an axle and brake assembly 400 of a vehicle such as vehicle 100 of FIG. 1. Axle and brake assembly 400 includes axle shaft 300 and an exemplary braking assembly 402 of a vehicle. Braking assembly 402 may be bolted to a wheel 420 that is configured to rotate around central axis 480, which is coaxially aligned with central axis 380 of axle shaft 300. A rotation of axle shaft 300 in either the clockwise direction 340 or the counterclockwise direction 342 generates a torque in wheel 420 that propels the vehicle in a forward or reverse direction. Axle shaft 300 is inserted into and couples with a hub 406 of a brake drum 408 of braking assembly 402. Braking assembly 402 may be bolted to a rim of wheel 420 via a plurality of wheel bolts that extend from an interior of brake drum 408 through a plurality of bolt holes 404 of brake drum 408.

First portion 320 of axle shaft 300 extends through hub 406, and is threaded into a locking nut 410 that secures axle shaft 300 to braking assembly 402. The first set of splines 302 are engaged with female splines arranged around an inner circumference of a hub 406. Axle and brake assembly 400 is described in greater detail in reference to FIG. 5, which shows an exploded view of axle and brake assembly 400.

FIG. 5 shows an exploded view 500 of axle and brake assembly 400 including axle shaft 300 and exemplary braking assembly 402. Braking assembly 402 comprises at least a brake drum 408, and a brake 510, which may be under the control of an original equipment manufacturer (OEM). Axle shaft 300 may be coupled to braking assembly 402 at brake drum hub 406, via a splined connection as described above. A radial inner circumference of hub 406 may include a set of inner splines configured to engage the first set of splines 302 arranged at the depicted end of axle shaft 300. Second axial length 309 of the first set of splines 302 may have a length equal to second axial length 309, such that the first set of splines 302 fully mesh with the set of inner splines of hub 406 when axle shaft 300 is fully inserted into hub 406. In some embodiments, axle shaft 300 may be fully inserted into hub 406 when lip 350 of axle shaft 300 is in face-sharing contact with a surface 540 of brake drum 408 at an edge of a central aperture of the brake drum through which first portion 320 protrudes. Sealing ring 308 may seal an interface between the first set of splines 302 and inner splines of hub 406 to prevent dirt and debris from passing between the first set of splines 302 and inner splines of hub 406. In some embodiments, the axle shaft is fully inserted into the hub when sealing ring 308 is in face-sharing contact with a surface 542 of the hub.

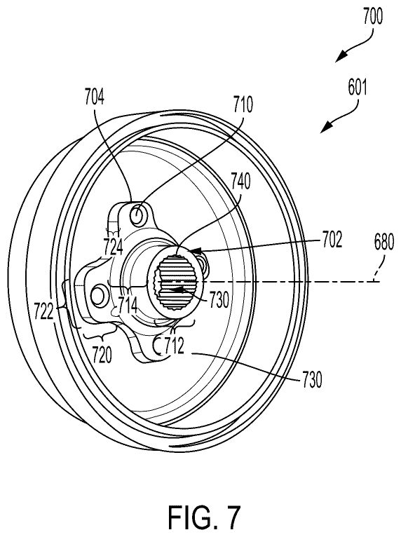

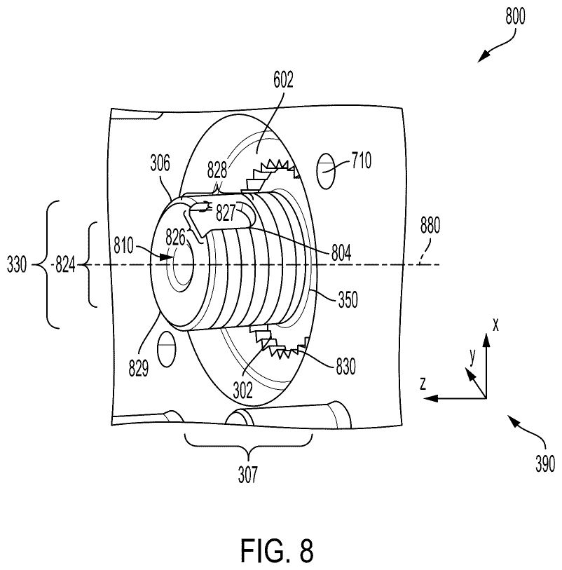

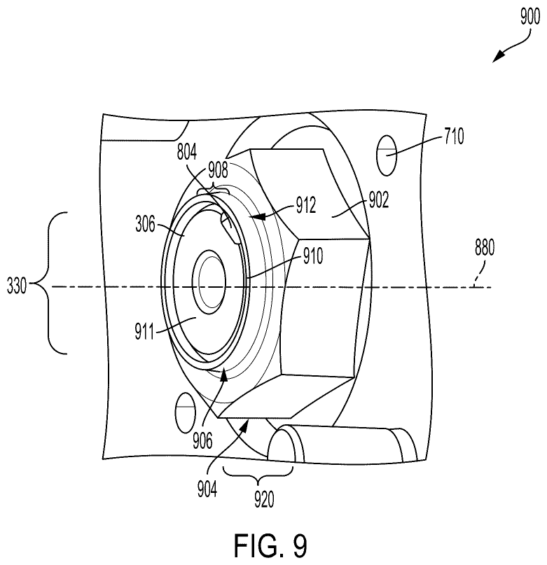

Hub 406 may be inserted (e.g., slid) into and coupled to a thickened portion 530 of brake drum 408, which may provide support for hub 406 and axle shaft 300. Thickened portion 530 is shown in greater detail in FIG. 7. When axle shaft 300 is fully inserted into hub 406, first portion 320 of axle shaft 300 extends through hub 406, such first portion 320 protrudes out from hub 406. In some embodiments, axle shaft 300 is coupled to brake drum 408 and held into place via a lock nut 502 that is rotatably coupled with (e.g., threaded onto) the protruding threaded section 306 of first portion 320. No other fasteners may be used apart from lock nut 502. Lock nut 502 has a depth 532 in the z dimension indicated by reference axes 390, which may be equal to or approximately equal to first axial length 307 of threaded section 306. In one embodiment, lock nut 502 may be locked via a lock pin 505, which may be inserted through an aperture of lock nut 502 that extends through lock nut 502 (depicted along an x dimension, or on an x/y plane in FIG. 5) at an outer edge 520 of lock nut 502 such that lock nut 502 cannot turn, thereby preventing lock nut 502 from loosening and securing axle shaft 300 to brake drum 408. In another embodiment, In other embodiments, lock nut 502 may not be locked via lock pin 505, and lock nut be a caulked nut, as described in greater detail below in reference to FIGS. 8 and 9. In other embodiments, first portion 320 of axle shaft 300 that protrudes through hub 406 may be coupled to brake drum 408 via a crimped nut, or a different mechanism.

During an assembly of axle and brake assembly 400, a wheel bearing 550 may be pressed on to axle shaft 300 and secured on the shaft using a retaining ring, also called as wedding ring (not shown in FIG. 5). In other embodiments, alternate wheel bearing arrangements may also be used such as a ball bearing, unitized bearing, double taper bearing, etc. Axle shaft 300 is then inserted into an axle housing such that the inboard splines (e.g., second set of splines 304) engage with side gear splines of a differential of the vehicle (differential gear assembly 124). The wheel bearing may then be secured in position in thickened portion 530 by a brake plate 512, which applies a clamping pressure on the wheel bearing 550. The brake assembly may be sandwiched between brake plate 512 and thickened portion 530 or may be outboard of the retainer plate (e.g., to the left in FIG. 5 along the z dimension), based on packaging and interface requirements. The drum may then be assembled on the axle shaft 300, and lock nut 502 may be torqued to secure axle shaft 300 to brake drum 408 and hub 406. Lock nut 502 is prevented from backing off, using lock pin 505, a caulking process, a crimping process, or a different mechanism.

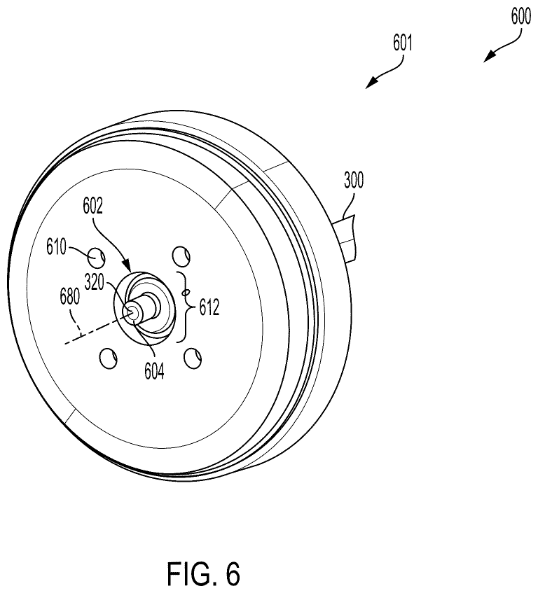

Brake drum 408 may be coupled to wheel 420 of FIG. 4 via a plurality of wheel bolts 504. Wheel bolts 504 may extend through a respective plurality of wheel bolt holes 506 of brake drum 408. A rim of wheel 420 may be bolted onto extending portions 509 of wheel bolts 504 via a respective plurality of lug nuts. Brake drum 408 is shown in greater detail in FIGS. 6 and 7. In contrast with conventional axle shaft 200 of FIG. 2, axle shaft 300 does not include a flange with holes through which wheel bolts 504 extend, such that axle shaft 300 may be bolted to wheel 420 through wheel bolt holes 506. Rather, the plurality of wheel bolts 504 may be pressed into drum 408.

FIG. 6 shows a first perspective view 600 of a coupling of axle shaft 300 with a brake drum 601, which may be a non-limiting example of brake drum 408 of FIGS. 4 and 5. First perspective view 600 is an exterior view of brake drum 601. Brake drum 601 includes a hub 602 (e.g., hub 406) positioned at a center of brake drum 601, coaxially aligned along a central axis 680 of brake drum 601. Hub 602 may be an integral part of brake drum 408. Axle shaft 300 is inserted into hub 602, along central axis 680, to establish the coupling. Hub 602 has an outer diameter 612, which may be equal to an inner diameter of brake drum 601. Axle shaft 300 may be coupled to hub 602 via the splined connection described in reference to FIG. 5.

First portion 320 of axle shaft 300 is shown extending through hub 602. Axle shaft 300 may be retained in hub 602 using a lock nut 604 (e.g., lock nut 502). Lock nut 604 may be implemented in various ways. In some embodiments, lock nut 604 may be a castle nut secured with a cotter pin (e.g., lock pin 505) for positive locking, to ensure that lock nut 604 does not back off. In other examples, lock nut 604 may be a crimped nut with a prevailing torque feature, or a nylock nut. In still other embodiments, lock nut 604 may be a caulked nut where the protruding portion of axle shaft 300 includes a slot, and lock nut 604 has a small thin wall at one end that may be caulked into the slot, as shown in greater detail in FIGS. 8 and 9. Additionally, threads on left and right axle shafts 300 may be opposite hand, to prevent lock nut 604 from loosening due to torque reactions (e.g., braking). That is, threaded section 306 may be threaded such that lock nut is tightened by turning lock nut 604 in a first rotational direction that is opposite a second rotational direction of axle shaft 300 during forward propulsion of the vehicle.

Brake drum 601 includes a first plurality of bolt holes 610 (e.g., bolt holes 404), through which a respective plurality of wheel bolts (e.g., wheel bolts 204 and/or 504) may be inserted to bolt brake drum 601 to a wheel of the vehicle.

FIG. 7 shows a second perspective view 700 of brake drum 601, which shows an interior of brake drum 601. As shown in second perspective view 700, brake drum 601 may include a hub 702 (e.g., hub 406) integrated into the interior of brake drum 601, meaning, formed of a same material as brake drum 601 during a process of manufacturing brake drum 601. Hub 702 may include an aperture 731 into which a portion of axle shaft 300 may be inserted. Hub 702 includes a plurality of internal splines 740, which engage with external splines of axle shaft 300 (e.g., first set of splines 302) when axle shaft 300 is inserted into hub 702.

Hub 702 has an inner diameter 712, which may be equal to an outer diameter of the external splines of axle shaft 300 (e.g., third diameter 332 of FIG. 3). Hub 702 has a height 714 (corresponding to a length of an engagement of the first set of splines 302 with the set of inner splines of hub 406) that is sufficient to support hub 702 and axle shaft 300. In one example, height 714 is 33 mm and inner diameter 712 is 38.1 mm. In other examples, height 714 and inner diameter 712 may be different.

Brake drum 601 may include a plurality of thickened portions 704 that extend radially outward from hub 702 along an inner surface 730 of brake drum 601. The plurality of thickened portions 704 may provide support for pressure exerted by a respective plurality of wheel bolts (e.g., wheel bolts 504). In one embodiment, the thickened portions 704 have a rectangular shape with a length 720, a width 722, and a height 724. The plurality of thickened portions 704 may include a respective plurality of bolt holes 710 (e.g., bolt holes 610), such that brake drum 601 may be coupled to a wheel by a respective plurality of wheel bolts (e.g., wheel bolts 504) inserted into through bolt holes 710.

FIG. 8 shows a perspective view 800 showing threaded section 306 of axle shaft 300 protruding through hub 602, in an embodiment where a caulked nut (not shown in FIG. 8) is used to secure axle shaft 300 to hub 602. The caulked nut is shown in FIG. 9. Threaded section 306 extends outward from lip 350 of axle shaft 300 along a central axis 880 (e.g., central axis 480, 680). The first set of splines 302 can be seen engaged with a set of inner splines 830 arranged around an inner circumference of the brake drum hub 602. In some embodiments, threaded section 306 may be hollow, and may include a central aperture 810 with a diameter 824, which may hold axle shaft 300 between centers during machining and datum reference for geometric dimensioning and tolerancing.

In particular, in the embodiment shown in FIG. 8, threaded section 306 includes a slot 804, which is recessed into threaded section 306 by a depth 827. Slot 804 may have a length 828 and a width 826. In various examples, length 828 is greater than width 826. For example, length 828 may extend most of a distance of first axial length 307 of threaded section 306 from an end 829 of axle shaft 300 towards lip 350. Slot 804 may be used to lock a nut (e.g., lock nut 502) to secure axle shaft 300 to hub 602, as shown in FIG. 9.

Referring now to FIG. 9, a perspective view 900 shows a lock nut 902 threaded on threaded section 306 of FIG. 8. Lock nut 902 may be a caulked nut including a first hexagonal portion 904, and a second portion 906 comprising a thin wall that surrounds an outer diameter of threaded section 306. First hexagonal portion 904 has a height 920 and provides surfaces for a torque to be applied to lock nut 902 to tighten lock nut 902 around threaded section 306. Second portion 906 has a height 908 that extends axially outward from hub 602, such that a flat outer circumferential surface 910 of the thin wall is even with or higher than a flat end surface 911 of threaded section 306. In particular, second portion 906 covers slot 804 in threaded section 306, as shown in FIG. 8. To secure lock nut 902 to threaded section 306 and to secure axle shaft 300 to hub 602, after torque is applied to first hexagonal portion 904 to tighten lock nut 902, a section 912 of the thin wall of second portion 906 may be deformed and caulked into slot 804 to prevent a rotation of lock nut 902. Once section 912 is caulked into slot 804, lock nut 902 may not be loosened.

Thus, an axle shaft is disclosed herein that engages with a hub and braking assembly of a vehicle via a splined connection, such that a flange of the axle shaft may be advantageously eliminated. As a result of using axle shaft 300 rather than axle shaft 200, (e.g., eliminating flange 214), a weight of axle shaft 300 may be reduced. In one example, an input weight to net weight ratio may be increased to 90%, as compared with 62% for conventional axle shaft 200 including a flange. With the ratio of 90%, the input weight of the bar used to forge axle shaft 300 is 10% more than the weight of the finished axle shaft 300. For example, if we have a finished axle shaft 200 that weighs 8 kg, then the input weight of the bar used to forge axle shaft 200 may be approximately 8×1.1=8.8 kg, representing 0.8 kg of wasted material, which is substantially less than the 3.03 kg of wasted material generated by forging axle shaft 200. Thus, by removing flange 214 from axle shaft 200, the amount of the wasted material is advantageously reduced. Additionally, the splined connection may have increased torque transmitting capability, more even distribution of stress, and increased shock resistance than an alternative bolted connection.

An additional advantage of axle shaft 300 over axle shaft 200 is that a process for assembling and disassembling braking assembly 402 may be less complex. For example, as a result of flange elimination, removal of brakes may be performed without dismantling hub 602. As a result, an amount of time taken for servicing braking assembly 402 may be reduced in a configuration where the brakes are outboard of a bearing retainer in a semi-float axle design. The technical effects of replacing a flange of an axle shaft with a splined connection to a brake drum hub is that an input weight to net weight ratio of the axle shaft may be reduced, a torque transmitting capability may be increased, stress may more evenly distributed, and an assembly and disassembly of the axle shaft from the brake drum may be less complex and time-consuming.

The disclosure also provides support for an axle and brake assembly of a vehicle, the axle and brake assembly comprising: an axle shaft including a first set of splines at a first end of the axle shaft, a brake drum with a hub including set of inner splines arranged around an inner circumference of the hub, the hub configured to receive the first set of splines and engage the first set of splines with the set of inner splines, and a lock nut configured to secure the axle shaft to the brake drum without any other fasteners, wherein the axle shaft does not include a flange. In a first example of the system, the axle shaft includes a second set of splines at a second end of the axle shaft, the second set of splines configured to engage with a gear of a differential gear assembly of the vehicle. In a second example of the system, optionally including the first example, the brake drum is bolted to a wheel of the vehicle via a plurality of wheel bolts, and a rotation of the axle shaft by the differential gear assembly generates a torque that is applied to the wheel via an engagement of the first set of splines with the set of inner splines. In a third example of the system, optionally including one or both of the first and second examples, the hub is integrated into the brake drum. In a fourth example of the system, optionally including one or more or each of the first through third examples, the brake drum includes a plurality of thickened portions that extend radially outward from the hub along an inner surface of the brake drum, the plurality of thickened portions including a set of bolt holes. In a fifth example of the system, optionally including one or more or each of the first through fourth examples, the axle shaft further comprises a sealing ring that protrudes radially outward from the axle shaft at a border of the first set of splines, the sealing ring configured to seal a coupling of the axle shaft with the hub and prevent dirt and debris from passing in between the first set of splines and the set of inner splines. In a sixth example of the system, optionally including one or more or each of the first through fifth examples, the axle shaft includes a threaded section at the first end, the threaded section having a diameter that is less than a second diameter of the axle shaft. In a seventh example of the system, optionally including one or more or each of the first through sixth examples, an axial length of the first set of splines is equal to an axial length of the set of inner splines, such that the first set of splines fully mesh with the set of inner splines when the axle shaft is fully inserted into the hub, the axle shaft fully inserted into the hub when a lip of the axle shaft at a border between the threaded section and the first set of splines is in face-sharing contact with a surface of the brake drum or when the sealing ring is in face-sharing contact with a surface of the brake drum. In a eighth example of the system, optionally including one or more or each of the first through seventh examples, the threaded section extends through the hub when the axle shaft is fully inserted into the hub. In a ninth example of the system, optionally including one or more or each of the first through eighth examples, the lock nut is threaded around the threaded section to secure the axle shaft to the brake drum, and a lock pin is inserted through an aperture of the lock nut that extends through the lock nut at an outer edge of the lock nut. In a tenth example of the system, optionally including one or more or each of the first through ninth examples, the threaded section is threaded such that the lock nut is tightened by rotating the lock nut in a first rotational direction opposite a second rotational direction of the axle shaft during forward propulsion of the vehicle. In a eleventh example of the system, optionally including one or more or each of the first through tenth examples, the lock nut is a castle nut. In a twelfth example of the system, optionally including one or more or each of the first through eleventh examples, the lock nut is a caulked nut that is deformed into a slot in the axle shaft to prevent the lock nut from turning.

The disclosure also provides support for an axle shaft of a vehicle, the axle shaft comprising: a first portion positioned at a first end of the axle shaft, the first portion including a threaded section having a first diameter, a second portion adjacent to the first portion, the second portion including a first set of splines radially extending outwards from the axle shaft, the second portion having a second diameter greater than the first diameter, a third, stepped portion adjacent to the second portion, having a diameter greater than the second diameter, a fourth portion positioned at a second, opposite end of the axle shaft, the fourth portion including a second set of splines radially extending outwards from the axle shaft, wherein the axle shaft does not include a flange. In a first example of the system, the first end of the axle shaft is configured to be inserted into a hub of a brake drum, such that the first set of splines engage with a second set of inner splines of the hub. In a second example of the system, optionally including the first example, the first portion is configured to extend through an aperture at the center of the hub when the first set of splines are engaged with the second set of inner splines, such that a lock nut can be rotatably coupled to the threaded section to couple the axle shaft to the brake drum, the lock nut including a lock pin to prevent the lock nut from loosening. In a third example of the system, optionally including one or both of the first and second examples, the system further comprises: a sealing ring positioned between the second portion and the third, stepped portion and protruding radially outward from the axle shaft to prevent dirt and debris from passing in between the first set of splines and the set of inner splines. In a fourth example of the system, optionally including one or more or each of the first through third examples, the second set of splines at the second, opposite end of the axle shaft are configured to engage with a gear of a differential gear assembly, such that a first torque generated on the axle shaft by the differential gear assembly generates a second torque at a wheel bolted to the brake drum, via a splined connection between the first set of splines of the axle shaft and the set of inner splines of the hub.

The disclosure also provides support for a method for generating a torque at a wheel of a vehicle, the method comprising: generating the torque from a rotation of an axle shaft of the vehicle via a first splined connection between a first set of splines positioned at a first end of the axle shaft and extending radially outward from the axle shaft, and a set of inner splines of a hub of a brake drum bolted to the wheel into which the axle shaft is inserted, the rotation generated by a second torque generated on the axle shaft by a differential gear assembly via a second splined connection between a second set of splines positioned at a second end of the axle shaft and extending radially outward from the axle shaft, and a gear of the differential gear assembly, wherein the axle shaft does not include a flange. In a first example of the method, the axle shaft is coupled to the hub via: a lock nut rotatably coupled to a threaded section of the axle shaft at the first end of the axle shaft, the threaded section protruding through the hub when the first set of splines is engaged with the set of inner splines, a lock pin inserted through an aperture at an outer edge of the lock nut, and no other fasteners.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

FIGS. 2-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. FIGS. 2-9 are drawn to scale, although other relative dimensions may be used if desired.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An axle and brake assembly of a vehicle, the axle and brake assembly comprising:
an axle shaft including a first set of splines at a first end of the axle shaft;
a brake drum with a hub including set of inner splines arranged around an inner circumference of the hub, the hub configured to receive the first set of splines and engage the first set of splines with the set of inner splines; and
a lock nut configured to secure the axle shaft to the brake drum without any other fasteners;
wherein the axle shaft does not include a flange.

2. The axle and brake assembly of claim 1, wherein the axle shaft includes a second set of splines at a second end of the axle shaft, the second set of splines configured to engage with a gear of a differential gear assembly of the vehicle.

3. The axle and brake assembly of claim 2, wherein the brake drum is bolted to a wheel of the vehicle via a plurality of wheel bolts, and a rotation of the axle shaft by the differential gear assembly generates a torque that is applied to the wheel via an engagement of the first set of splines with the set of inner splines.

4. The axle and brake assembly of claim 3, wherein the hub is integrated into the brake drum.

5. The axle and brake assembly of claim 4, wherein the brake drum includes a plurality of thickened portions that extend radially outward from the hub along an inner surface of the brake drum, the plurality of thickened portions including a set of bolt holes.

6. The axle and brake assembly of claim 1, wherein the axle shaft further comprises a sealing ring that protrudes radially outward from the axle shaft at a border of the first set of splines, the sealing ring configured to seal a coupling of the axle shaft with the hub and prevent dirt and debris from passing in between the first set of splines and the set of inner splines.

7. The axle and brake assembly of claim 6, wherein the axle shaft includes a threaded section at the first end, the threaded section having a diameter that is less than a second diameter of the axle shaft.

8. The axle and brake assembly of claim 7, wherein an axial length of the first set of splines is equal to an axial length of the set of inner splines, such that the first set of splines fully mesh with the set of inner splines when the axle shaft is fully inserted into the hub, the axle shaft fully inserted into the hub when a lip of the axle shaft at a border between the threaded section and the first set of splines is in face-sharing contact with a surface of the brake drum or when the sealing ring is in face-sharing contact with a surface of the brake drum.

9. The axle and brake assembly of claim 8, wherein the threaded section extends through the hub when the axle shaft is fully inserted into the hub.

10. The axle and brake assembly of claim 9, wherein the lock nut is threaded around the threaded section to secure the axle shaft to the brake drum, and a lock pin is inserted through an aperture of the lock nut that extends through the lock nut at an outer edge of the lock nut.

11. The axle and brake assembly of claim 10, wherein the threaded section is threaded such that the lock nut is tightened by rotating the lock nut in a first rotational direction opposite a second rotational direction of the axle shaft during forward propulsion of the vehicle.

12. The axle and brake assembly of claim 10, wherein the lock nut is a castle nut.

13. The axle and brake assembly of claim 12, wherein the lock nut is a caulked nut that is deformed into a slot in the axle shaft to prevent the lock nut from turning.

14. An axle shaft of a vehicle, the axle shaft comprising:
a first portion positioned at a first end of the axle shaft, the first portion including a threaded section having a first diameter;
a second portion adjacent to the first portion, the second portion including a first set of splines radially extending outwards from the axle shaft, the second portion having a second diameter greater than the first diameter;
a third, stepped portion adjacent to the second portion, having a diameter greater than the second diameter;
a fourth portion positioned at a second, opposite end of the axle shaft, the fourth portion including a second set of splines radially extending outwards from the axle shaft;
wherein the axle shaft does not include a flange.

15. The axle shaft of claim 14, wherein the first end of the axle shaft is configured to be inserted into a hub of a brake drum, such that the first set of splines engage with a second set of inner splines of the hub.

16. The axle shaft of claim 15, wherein the first portion is configured to extend through an aperture at the center of the hub when the first set of splines are engaged with the second set of inner splines, such that a lock nut can be rotatably coupled to the threaded section to couple the axle shaft to the brake drum, the lock nut including a lock pin to prevent the lock nut from loosening.

17. The axle shaft of claim 14, further comprising a sealing ring positioned between the second portion and the third, stepped portion and protruding radially outward from the axle shaft to prevent dirt and debris from passing in between the first set of splines and the set of inner splines.

18. The axle shaft of claim 15, wherein the second set of splines at the second, opposite end of the axle shaft are configured to engage with a gear of a differential gear assembly, such that a first torque generated on the axle shaft by the differential gear assembly generates a second torque at a wheel bolted to the brake drum, via a splined connection between the first set of splines of the axle shaft and the set of inner splines of the hub.

19. A method for generating a torque at a wheel of a vehicle, the method comprising:
generating the torque from a rotation of an axle shaft of the vehicle via a first splined connection between a first set of splines positioned at a first end of the axle shaft and extending radially outward from the axle shaft, and a set of inner splines of a hub of a brake drum bolted to the wheel into which the axle shaft is inserted, the rotation generated by a second torque generated on the axle shaft by a differential gear assembly via a second splined connection between a second set of splines positioned at a second end of the axle shaft and extending radially outward from the axle shaft, and a gear of the differential gear assembly;
wherein the axle shaft does not include a flange.

20. The method of claim 19, wherein the axle shaft is coupled to the hub via:
a lock nut rotatably coupled to a threaded section of the axle shaft at the first end of the axle shaft, the threaded section protruding through the hub when the first set of splines is engaged with the set of inner splines;
a lock pin inserted through an aperture at an outer edge of the lock nut;
and no other fasteners.
